(19) United States
(12) Patent Application Publication
(10) Pub. No.: US 2022/0153393 A1
(43) Pub. Date: May 19, 2022

(54) ELECTRIC WATERBORNE TRANSPORT SYSTEMS AND METHODS

(71) Applicant: Peigen Jiang, Sammamish, WA (US)

(72) Inventor: Peigen Jiang, Sammamish, WA (US)

(21) Appl. No.: 17/098,459

(22) Filed: Nov. 16, 2020

(51) Int. Cl. B63B 35/44; B60L 5/00; B60L 8/00; B63H 19/00; B60L 53/16; F03D 9/25; H02J 3/38

(52) U.S. Cl. CPC B63B 35/44; B60L 5/00; B60L 8/006; B63H 19/00; B60L 53/16; H02J 2300/28; H02J 3/381; B60L 2200/32; B63B 2035/446; F05B 2220/706; F03D 9/25

(57) ABSTRACT

An electric waterborne transport system is disclosed which includes a plurality of electric power generators deployed over a waterbody, the plurality of electric power generators generating electricity from a renewable energy source, and a power line suspended above a surface of the waterbody and spanning between two distant destinations, the power line receiving electricity from the plurality of electric power generators and transmitting the electricity to a cargo ship to propel the cargo ship to travel along the power line.

### BACKGROUND

The present disclosure relates generally to the field of waterborne transport, and, more particularly, to systems and methods for electric waterborne transport.

Conventional waterborne transport replies on cargo ships running on fossil fuels. Due to large volume of international trade, ocean freight transport industry has become a major contributor to greenhouse gas emissions. As such cargo ships usually travel great distances, clean energy from either battery or hydrogen are not practical due to their low energy density. As such what is needed is systems and methods that supply electricity to ships en route of their travels.

### SUMMARY

An electric waterborne transport system is disclosed which includes a plurality of electric power generators deployed over a waterbody, the plurality of electric power generators generating electricity from a renewable energy source, and a power line suspended above a surface of the waterbody and spanning between two distant destinations, the power line receiving electricity from the plurality of electric power generators and transmitting the electricity to a cargo ship to propel the cargo ship to travel along the power line.

### BRIEF DESCRIPTION OF THE DRAWING

FIG. 1 illustrates an offshore electric power grid supplying power to traveling cargo ships according to embodiments of the present disclosure.

FIGS. 2A and 2B illustrate systems for transmitting electricity from the offshore electric power grid to a cargo ship according to embodiments of the present disclosure.

FIG. 3 illustrates a structure for allowing a ship to pass through a gap between two neighboring wind turbines according to embodiments of the present disclosure.

FIGS. 4A and 4B illustrate an alternative passageway transverse to the power line according to embodiments of the present disclosure.

The drawings accompanying and forming part of this specification are included to depict certain aspects of the disclosure. A clearer conception of the disclosure, and of the components and operation of systems provided with the disclosure, will become more readily apparent by referring to the exemplary, and therefore non-limiting, embodiments illustrated in the drawings, wherein like reference numbers (if they occur in more than one view) designate the same elements. The disclosure may be better understood by reference to one or more of these drawings in combination with the description presented herein.

### DESCRIPTION

The present disclosure relates to electric waterborne transport systems and methods. A preferred embodiment of the present disclosure will be described hereinafter with reference to the attached drawings.

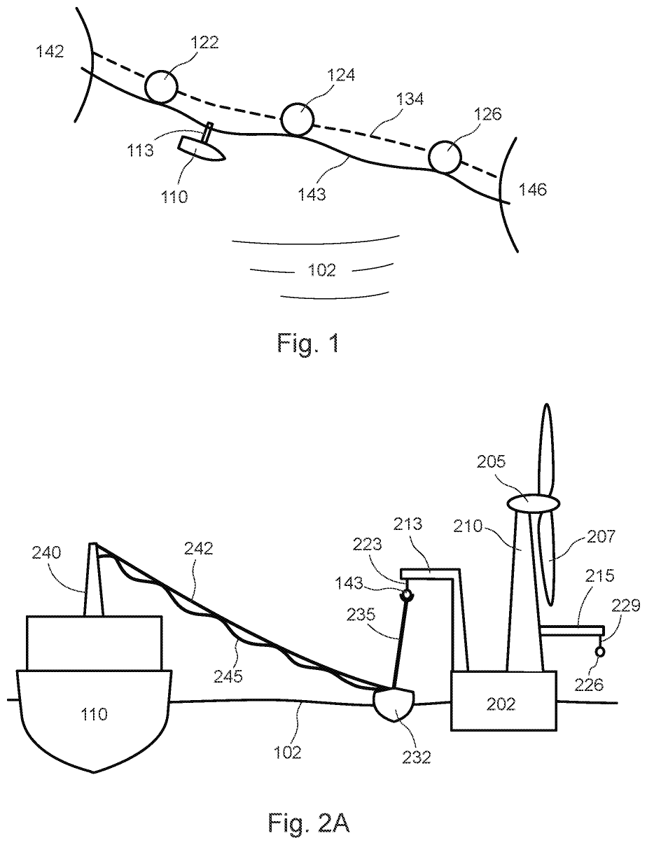

FIG. 1 illustrates an offshore electric power grid 134 supplying power to traveling cargo ships according to embodiments of the present disclosure. The offshore electric power grid 134 is electrically connected to a plurality of power generators 122, 124 and 126 floating on a surface of a waterbody 102. The plurality of power generators 122, 124 and 126 generates electricity from a renewable energy source such as wind or water wave. In embodiments, the electric power grid 134 is disposed on the bottom of the waterbody 102 and is linked to an onshore electric power grid (not shown), so that the offshore generated electricity can also be used by onshore consumers.

As shown in FIG. 1, a power line 143 is electrically connected to the power grid 134 for supplying electricity to a traveling cargo ship 110 via a trolley structure 113. The electricity powers the cargo ship 110 to travel along a path of the power line 143 from a first destination 142 to a second destination 146. The first destination 142 can be of a great distance from the destination 146, for instance, from Seattle to San Francisco. In embodiments, the plurality of power generators 122, 124 and 126 are anchored to a bottom of the waterbody 102. In other embodiments when the waterbody is too deep for anchoring, the plurality of power generators 122, 124 and 126 are linked together by chains (not shown) to maintain their relative distances so that the power line 143 will not be disrupted.

In embodiments, the plurality of power generators 122, 124 and 126 employ wind turbines to generate electricity. To increase capacity of the electric power grid 134, multiple wind turbines may be connected and jointly supplying power to a location of the power line 143. For instance, the power generator 122 may represent multiple connected wind turbines. In other embodiments, wind tunnels may be used to generate electricity in typhoon or hurricane frequented areas.

FIGS. 2A and 2B illustrate systems for transmitting electricity from the offshore electric power grid 134 to a cargo ship according to embodiments of the present disclosure. Referring to FIG. 2A, an exemplary wind turbine 205 is mounted on a tower 210 which in turn is mounted on a floating barge 202. The floating barge 202 also carries a L-shaped post 213 with an arm extending over a first edge of the floating barge 202. The L-shaped post 213 is used to suspend the power line 143 by a cable 223.

Referring again to FIG. 2A, a trolley boat 232 travels beneath the power line 143 and draws electric power therefrom using a spring-loaded trolley structure 235. The electric power can be in a form of either direct current (DC) or alternate current (AC). The power line 143 may include two or more electrical wires and the trolley structure 235 may include corresponding number of poles each containing an electrical wire to complete an electric circuit. As the water surface 102 can be wavy at times, in order to make a reliable continuous contact between the trolley structure 235 and the power line 143, the trolley boat 232 may employ two or more trolley structures simultaneously making contact with the power line 143. In embodiments, the trolley structure 235 may use pantographs instead of poles for contacting the power line 143. Both pantographs and poles may employ graphite contact strip in making the contact.

In embodiments, the trolley boat 232 is propelled by electric motors and has an on-board rechargeable battery. When the trolley structure 235 is contacting the power line 143, the electric motors use electricity from the power line 143 which also charges the rechargeable battery. When the trolley structure 235 is not in contact with the power line 143, the rechargeable battery powers the electric motors to maneuver the trolley boat 232 to reach the power line 143. The trolley boat 232 may employ multiple electric motors to enhance its maneuverability. As the trolley boat 232 is small and very maneuverable, a continuous contact by the trolley structure 235 to the power line 143 can be easily maintained.

Referring again to FIG. 2A, the trolley boat 232 is tied to a cargo ship 110 by a cable 242 which suspends an electrical wire 245. The electrical wire 245 transmits electricity received from the electric power grid by the trolley boat 232 to the cargo ship 110. In embodiments, an end of the cable 242 is raised by a mast 240 on the cargo ship 110, so that the trolley boat 232 sustains less laterally pulling force. A length of the cable 242 along with a length of the electrical wire 245 can be dynamically adjusted by a pully system (not shown), so that when the cargo ship 110 drifts away from the trolley boat 232, the pully system can extend the length of the cable 242 without pulling the trolley boat 232 away from the power line 143. As long as the cargo ship 110 receives electricity from the electric power line 143, the cargo ship 110 can correct its course and maintain a desired distance to the trolley boat 232. The trolley boat 232 is controlled to move at the same speed as the cargo ship 110.

Referring again to FIG. 2A, a horizontal structure 215 is extended from the tower 210 over a second edge of the floating barge 202 which is opposite to the first edge. The horizontal structure 215 suspends another power line 226 by a cable 229. The power line 226 is for supplying electricity to ships (not shown) traveling in a direction opposite to that of the cargo ship 110. In embodiments, the horizontal structure 215 and thus the power line 226 are lower than blades 207 of the wind turbine 205 for easy installation.

Referring to FIG. 2B, a spring-loaded trolley structure 253 for engaging the power line 143 is attached to a flexible arm 251 extended directly from the cargo ship 110. To counter a relative movement between the cargo ship 110 and the power line 143, the flexible arm 251 can swivel both horizontally and vertically around a pivotal point 256. The flexible arm 251 also has multiple telescopic sections so that the flexible arm 251 can extend or retract it length. The movements by the flexible arm 251 are motorized and controlled by various sensors measuring at least tensions at the spring-loading trolley structure 253. To compensate a weight of the flexible arm 251, a cable 259 may be used between a top of the mast 240 and a end of the flexible arm 251. As shown in FIG. 2B, the power line 143 is suspended by a floating post 263 and connected to the power grid (not shown) by a power cable 267.

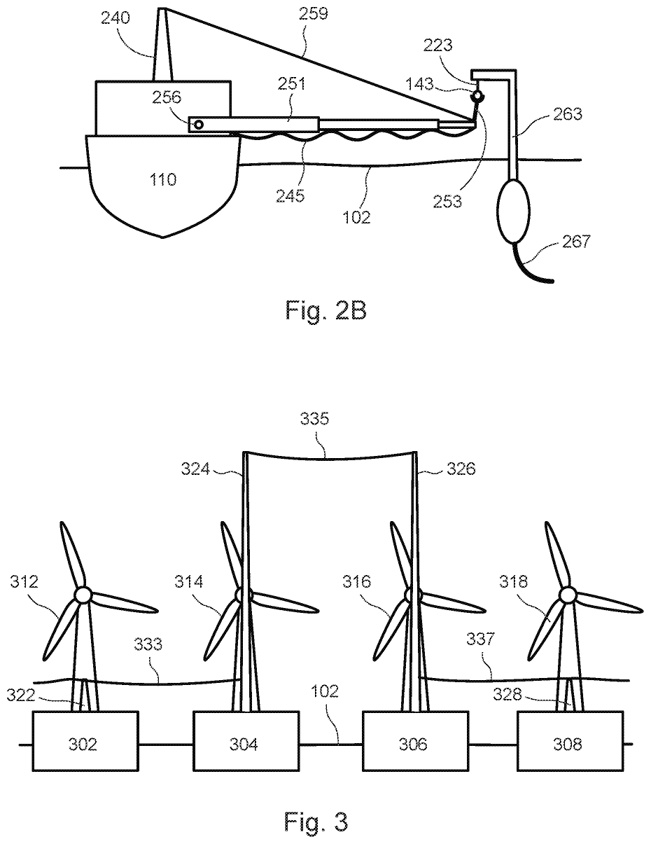

FIG. 3 illustrates a structure for allowing a ship to pass through a gap between two neighboring wind turbines according to embodiments of the present disclosure. As shown in FIG. 3, four exemplary wind turbines 312, 314, 316 and 318 are mounted on four floating barges 302, 304, 306 and 308, respectively. A power line 333 between the floating barges 302 and 304 is suspended at a normal height power posts 322 and 324. A power line 337 between the floating barges 306 and 308 is suspended at the normal height by power posts 326 and 328. The normal height is designed for being reached by the trolley structures 235 and 253 shown in FIGS. 2A and 2B, respectively. A power line 335 between the floating barge 304 and 306 can be raised to an elevated height by the tall power posts 324 and 326, so that ships can pass through the gap between the floating barges 304 and 306 underneath the power line 335. When the cargo ship 110 shown in FIGS. 2A and 2B needs to travel from the floating barge 304 to the floating barge 306, the power line 335 will be lowered to the normal height. In embodiments, the tall power posts 324 and 326 have a fixed height, the power line 335 can be moved up and down along the length of the power posts 324 and 326. Alternatively, the tall power posts 324 and 326 is telescopic, and can adjust their heights between the normal height and the elevated height. In embodiments, the power lines 333, 335 and 337, regardless their height, are electrically connected to complete an electric circuit for the electric power grid.

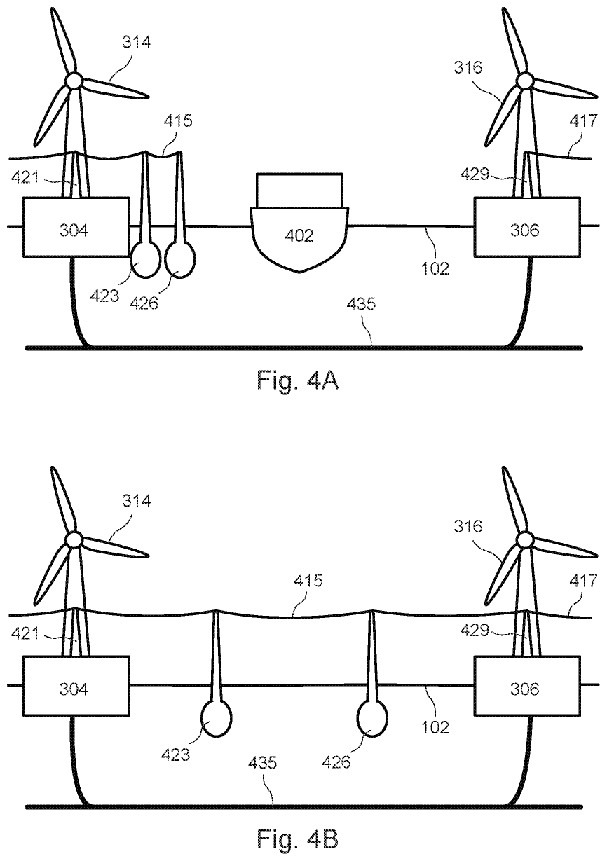

FIGS. 4A and 4B illustrate an alternative passageway transverse to the power line according to embodiments of the present disclosure. Referring to FIG. 4A, two neighboring wind turbines 314 and 316 are electrically connected by a submerged power cable 435, so that power lines 415 and 417 can be disconnected to open a passageway transverse to the power line 415 and 417 for a ship 402 to pass through the gap between the floating barges 304 and 306. In embodiments, the power line 415 is supported by two floating posts 423 and 426 which are parked near the floating barge 304.

Referring to FIG. 4B, when there is no need for a transverse passageway, the power lines 415 and 417 are connected for supplying electricity to a cargo ship traveling from the floating barge 304 to the floating barge 306. At this time, the floating posts 423 and 426 are moved to positions that support a middle section of the power line 415. In embodiments, the power line 415 is carried from the floating barge 304 to the floating barge 306 by a flying drone or a small boat. In such case, one or more cables may be first deployed between the floating barges 304 and 306, then the cables pull the floating posts 423 and 426 to their designated positions as well as pull the power line 415 from the floating barge 304 to the floating barge 306 to be connected with the power line 417.

In embodiments, the submerged power cable 435 is a part of the offshore electric power grid that connects all the wind turbines in the network. The power cable 435 may carry a high voltage AC or DC which is transformed to a low voltage to the power lines 415 and 417.

Although the disclosure is illustrated and described herein as embodied in one or more specific examples, it is nevertheless not intended to be limited to the details shown, since various modifications and structural changes may be made therein without departing from the spirit of the disclosure and within the scope and range of equivalents of the claims. Accordingly, it is appropriate that the appended claims be construed broadly and in a manner consistent with the scope of the disclosure, as set forth in the following claims.

What is claimed is:

1. An electric waterborne transport system comprising:
a plurality of electric power generators deployed over a waterbody, the plurality of electric power generators generating electricity from a renewable energy source; and
a power line suspended above a surface of the waterbody and spanning between two distant destinations, the power line receiving electricity from the plurality of electric power generators and transmitting the electricity to a cargo ship to propel the cargo ship to travel along the power line.

2. The electric waterborne transport system of claim 1, wherein the plurality of electric power generators includes wind turbines.

3. The electric waterborne transport system of claim 1, wherein the plurality of electric power generators is disposed in a vicinity of the power line between the two distant destinations.

4. The electric waterborne transport system of claim 1, wherein the plurality of electric power generators is electrically connected to a power grid that reaches a land.

5. The electric waterborne transport system of claim 4, wherein the power grid is submerged in the waterbody.

6. The electric waterborne transport system of claim 1, wherein the waterbody is a sea, and the two distant destinations are two separate seaports.

7. The electric waterborne transport system of claim 1, wherein the power line includes two electric wires to complete a circuit.

8. The electric waterborne transport system of claim 1, wherein the power line is supported by a floating post.

9. The electric waterborne transport system of claim 1, wherein the power line is temporarily disconnected at a predetermined location to make a passageway transverse to the power line.

10. The electric waterborne transport system of claim 1, wherein the power line is temporarily raised at a predetermined location to make a passageway transverse to the power line.

11. The electric waterborne transport system of claim 1 further comprising a conductive member sliding along and making continuous contact to the power line.

12. The electric waterborne transport system of claim 11, wherein the conductive member is mounted on a spring-loaded trolley pole extending from a motorized boat, and the conductive member and the trolley pole conduct electricity from the power line to the motorized boat.

13. The electric waterborne transport system of claim 12, wherein the motorized boat is linked to the cargo ship and transmits electricity received from the power line to the cargo ship.

14. The electric waterborne transport system of claim 11, wherein the conductive member is mounted to a flexible arm extending from the cargo ship for transmitting electricity from the power line to the cargo ship.

15. The electric waterborne transport system of claim 14, wherein the flexible arm is motorized and controlled to move in three dimensions to counter a relative movement between the cargo ship and the power line, so that the conductive member can make continuous contact with the power line.

16. A method for propelling a cargo ship with electricity, the method comprising:
deploying a plurality of electric power generators over a waterbody, the plurality of electric power generators generating electricity from a renewable energy source;
electrically connecting the plurality of electric power generators to a power line suspended above a surface of the waterbody and spanning between two distant destinations; and
transmitting electricity from the power line to the cargo ship for driving an electric motor to propel the cargo ship to travel along the power line.

17. The method of claim 16 further comprising temporarily disconnecting the power line at a predetermined location to make a passageway transverse to the power line.

18. The method of claim 16 further comprising temporarily raising the power line at a predetermined location to make a passageway transverse to the power line.

19. The method of claim 16 further comprising providing a conductive member sliding along and making continuous contact with the power line.

20. The method of claim 19, wherein the conductive member is flexibly coupled to the cargo ship and conducting electricity from the power line to the cargo ship.
